(19) United States
(12) Patent Application Publication
(10) Pub. No.: US 2006/0219275 A1
(43) Pub. Date: Oct. 5, 2006

(54) Device for cleaning wafers after a cmp process

(75) Inventors: Martin Weber, Elzach (DE); Norbert Bürger, Kirchzarten (DE)

Correspondence Address: WALL MARJAMA & BILINSKI, 101 SOUTH SALINA STREET, SUITE 400, SYRACUSE, NY, 13202, US

(73) Assignee: RENA SONDERMASCHINEN GMBH, GUTENBACH (DE)

(21) Appl. No.: 10/555,998

(22) PCT Filed: Jul. 9, 2003
(86) PCT No.: PCT/EP03/07373

§ 371 Date: Nov. 8, 2005

(51) Int. Cl. B08B 3/02

(52) U.S. Cl. 134/64 R; 134/902; 134/67; 134/68; 134/69

(57) ABSTRACT

An apparatus for cleaning wafers using the CMP process includes a transport device of a feeding station at the beginning of a cleaning line which has a plurality of transport rollers disposed and driven transversely to the direction of transport. The cleaning line transports polished wafers to a main cleaning station having several pairs of transport rollers for transporting the wafers through the main cleaning station and several pairs of cleaning rollers for cleaning the wafers, wherein a supply of a cleaning medium to the pairs of cleaning rollers is provided in the main cleaning station. A withdrawal station is disposed at the end of the cleaning line in which a robot takes up a wafer and transports it to a drying station, wherein the withdrawal station has a first detector. A water cushion transport line is disposed between the main cleaning station and the withdrawal station and a stop station is disposed between the main cleaning station and the withdrawal station which has associated thereto a second detector. A control device presets a predetermined ratio of the speed of the transport rollers of the transport device and that of the pairs of transport rollers of the main cleaning station and does not release a transport to the feeding station until there is no wafer at the stop station, and releases a wafer to the withdrawal station only when there is no wafer therein.

This invention relates to an apparatus for cleaning wafers using the CMP process.

Whenever a semiconductor wafer has been coated, e.g. with an oxide layer, a tungsten layer or other metallic layers, it requires to be processed to provide the planarity desired. If such planarity is not provided problems will occur during lithographic procedures, for example, perhaps in the form of malfocus or in the form of conductor track cracks. A planarization method in the semiconductor industry uses the co-called CMP process. This is a chemico-mechanical treatment by means of a fluid (slurry) in which the function of the chemically reactive component of the slurry is to convert the material into a polishable state. This slurry contains an grinding medium in the form of colloidal abrasive particles. DE 197 19 503 A1 describes a device for the CMP process having at least one polishing plate and a carrier which retains the semiconductor wafer and, while being rotated about its axis, forces it against the rotating polishing plate. The carrier provides for a homogeneously pressed area.

Slurry residues and particles will be left on the wafer surface after the polishing procedure. If the slurry residues and particles dried and stuck in place the circuits on the wafer would be destroyed. Therefore, it is necessary to clean and dry the wafers after the polishing process before they are sent to undergo further processes.

It is the object of the invention to provide an apparatus for cleaning wafers using the CMP process, which is of a simple structure and has a high efficiency and ensures gentle treatment during cleaning and transport. It further is meant for allowing chemical treatment.

The object is achieved by the features of claim1 1 and 2.

The inventive cleaning apparatus includes a feeding station with a first transport device which picks the polished wafer tip and conveys it to a main cleaning station. Transport rollers are provided for this purpose on which the wafers are transported. The main cleaning station also has rollers, i.e. pairs thereof, with certain pairs of rollers serving the transport and other pairs of rollers serving for cleaning. To this end, a cleaning medium is fed to the pairs of cleaning rollers. At the end of the conveyance line of the inventive cleaning apparatus, a withdrawal station is provided from which the wafers which were cleaned, but are still wet, can be sent to a drying station. A stop station is provided between the main cleaning station and the withdrawal station which provides for the wafer to be halted when there is still a wafer in the withdrawal station. Moreover, a presence detector arranged in the stop station takes care that a wafer be not transported by the first transport device to the main cleaning station as long as there is a wafer at the stop station. A control device causes the detector signals to be processed at the stop station and withdrawal station and possibly at the feeding station, and the functions to be triggered in the individual stations. The control device further takes care that the transport speed in the first transport device and the main cleaning station be harmonized so that a waver is gently transported into the main cleaning station.

According to claim 2, a main cleaning station, a start position preceding the main cleaning station, and a drying station as well as a stop station are arranged between the main cleaning station and drying station along a transport runway which is of a V-shaped configuration, wherein the main cleaning station is associated with the first leg and the drying station is associated with the second leg of the V-shaped runway. If the apparatus is disposed in a cleanroom in which also the preceding processes run by means of respective mechanical facilities it is useful, according to an aspect of the invention, for the second leg of the V-shaped runway to extend approximately in parallel with one side of the cleanroom. Preferably, the stop station is disposed in the apex area of the V-shaped runway.

The feeding station of the inventive apparatus is provided with a stationary facility to deposit the wafers where a robot is used, for example, to lower the polished wafer onto the deposit area. According to an aspect of the invention, the facility may be defined by retaining pins, which are adjustable in height and are disposed between transport rollers to lower a wafer onto the transport rollers. It is preferred to drive the transport rollers at the same speed. The design of their control is such as to regulate their speed relative to the speed of the transport rollers in the main cleaning station.

The main cleaning station of the inventive apparatus has arranged therein several pairs of rollers with some of the pairs of rollers provided to transport the wafers and other pairs provided to clean them. The latter are preferably driven in a sense of rotation opposed to the direction of transport in order to achieve an enhanced cleaning effect. It is understood that the wafers are efficiently transported in the main cleaning station although the sense of rotation of the cleaning rollers is opposed thereto. The pairs of rollers may be disposed inside a closed casing which has lateral inlet and outlet openings for the wafer and allows an intended guidance of air within the casing. A collection tray is arranged in the lower portion of the casing for the cleaning liquid which is fed to the cleaning rollers. Besides, the lower portion of the casing may be connected to exhaust air. The liquids used are chosen so as to enable the use of acids and liquors as a cleaning solution in the pH range between 1 and 13 in a permanent operation. The drives of the rollers may be designed such as to allow the transport rollers for cleaning to be driven at different speeds.

According to another aspect of the invention, it is beneficial for the rollers of the pairs of rollers to be forced against the wafer at a predetermined contact pressure to ensure an equal contact pressure which does not depend on the thickness of the wafer and wearing effects. For this purpose, the upper and lower rollers may be supported by independent frames which are pressed against each other via a pneumatic or hydraulic regulation. It is also conceivable for the main cleaning station to position a flushing line at the beginning and at the end that ensures a lock and flushing function.

It is advantageous to apply the chemicals to the cleaning rollers dropwise to achieve a low consumption of chemicals. For a uniform application to the cleaning rollers over their full length, a drop distributor is provided the movement of which is designed such as to make the dwell time above each roller portion equally long.

The supply of media to the drop distributor is maintained constant by means of an appropriate media treatment comprising a mixing tank, a pump tank, flow rate sensors, flow rate controllers, and proportioning pumps. An arrangement of flow rate controllers in the supply lines allows to adjust any mixing and dilution ratios for process chemicals.

A final cleaning procedure can follow subsequent to the main cleaning station and can be carried out in various manners. One possible way is to use a cleaning station as is used for the main cleaning station, i.e. the arrangement of pairs of rollers comprising pairs of transport rollers and pairs of cleaning rollers. Those pairs of rollers can be arranged and operated in the same manner as was described in conjunction with the main cleaning station. Such a second cleaning station can also be used to perform well-intended etching processes. Instead of a cleaning liquid, an etching chemical can then be applied to the cleaning and processing rollers.

According to the invention, a flushing lock may be interposed between the stations to prevent the chemicals from entering into contact with each other if different ones are used in the main cleaning and final cleaning stations. The lock preferably is of a length which is smaller than the diameter of the wafers. This allows a transport through the flushing lock exclusively by means of the transport rollers of the main cleaning and final cleaning stations. The flushing lock may have arranged therein a pair of cleaning rollers which preferably are driven against the direction of transport to produce a cleaning effect. Furthermore, an appropriate supply of rinsing agents may be effected onto the wafer to eliminate residues still left behind on the wafer before it enters the final cleaning station.

As an alternative or in addition to a second roller-operated cleaning station, a Megasonic station may be provided to eliminate very small particles <0.5 μm. There are three different possible ways to do so. In the case of a single-chamber system, the wafer may be held by its edge by means of retaining pins or the like and may be immersed into a coupling liquid to enable it to be cleaned by means of transducers arranged above and below the wafer. Apart from a cleaning liquid, chemicals can be employed the pH of which ranges from 2 to 11. Furthermore, it is possible to fit the cleaning chamber with a water cushion transport system to remove the wafer from the station and transport it on.

The other possible way, a Megasonic cleaning system, exists during the transport of the wafer by arranging several transducers above and below the transport runway. Inflow openings for the cleaning liquid may be provided between the transducers. The cleaning liquid also serves for ensuring a bridge of liquid between the transducers and the workpiece. A liquid drain may also exist between the Megasonic fields to discharge the load of particles along with the cleaning liquid.

Finally, it is possible to use a Megasonic nozzle system in which a wafer is gripped by its edge and is held on a rotor which is set into rotation during the cleaning process. While the wafer rotates a Megasonic nozzle unit is radially traversed across the surface of the wafer. The cleaning liquid is fed through the Megasonic nozzle. This automatically results in an ultrasonic sound coupling between the transducer and workpiece.

It is preferred to provide a transport runway by the use of water cushions between the main cleaning station and possibly the final cleaning station, and the withdrawal station from which the wafers are transported to the drying station. The transport by a water cushion may be performed within a closed channel system. The workpiece will move on a closed liquid film within the channel with its forward transport taking place by the directional flow of water. The water cushion and an extra flushing process on the surface through a spray nozzle system allows to accomplish a permanent flushing process on either side of the wafer during its transport. The flushing liquid used typically will be DI water (deionized water). Likewise, diluted chemicals may be used for specific applications. The main drain for the flushing liquid is at the end of the channel, but more drains can be interposed to ensure a better discharge of particles and chemicals.

While being transported, the wafer is stopped in order to provide a buffering function. For this purpose, a plurality of retaining pins may be raised into the transport runway where a workpiece identification system discovers whether there is a wafer in the stop position. Not until the wafer is released from the stop position a supply of another wafer can be performed to the main cleaning station. Likewise, a wafer will not be released from the stop position until the withdrawal station is vacant.

Preferably, a transport by a water cushion also takes place into a lifter unit behind the stop station. When the wafer is inside it will run against a retaining pin, for example, and is gripped by its edge by further retaining pins which then jointly raise the wafer to allow it to be picked up by a robot, for example, for its transport to the drying station.

The drying station preferably is defined by a flushing and drying hydroextractor with a rotor rotating the waver at a predetermined speed. A flushing medium, gas, vapour or liquid is directed against the wafer during a first phase. Drying is effected by a gas or mixture of an inert gas and a carrier gas during the second phase, e.g. by nitrogen or a vapour of a water-soluble, surface tension reducing substance, preferably a short-chained alcohol such as isopropanol.

The invention will be described in more detail below with reference to the embodiments shown in the drawings.

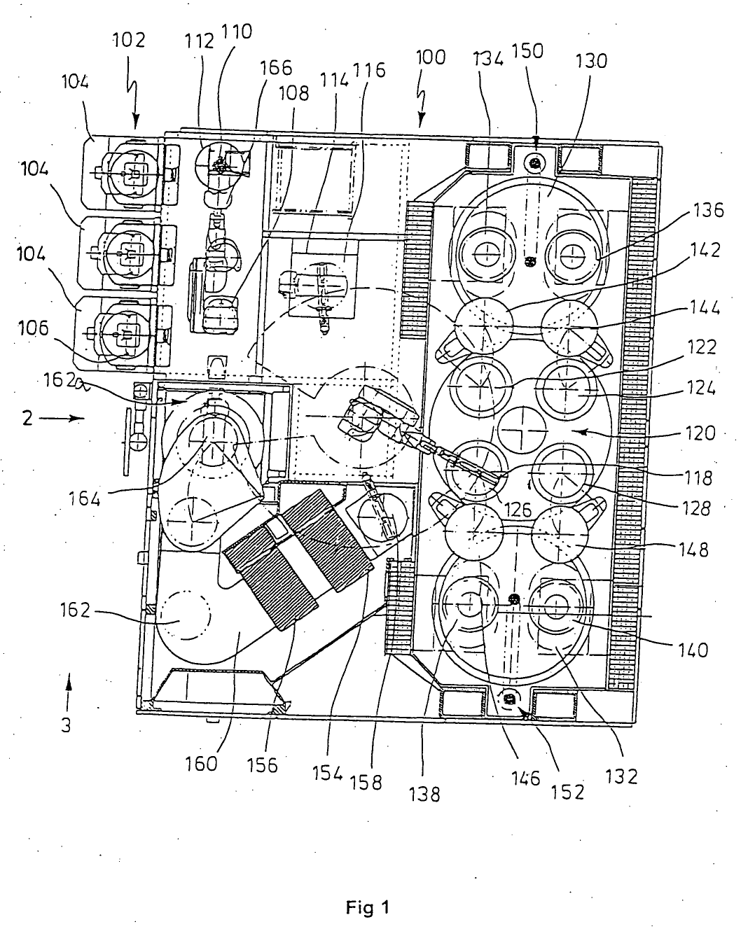

FIG. 1 shows a plan view of an apparatus for transporting, polishing, washing, and drying wafers.

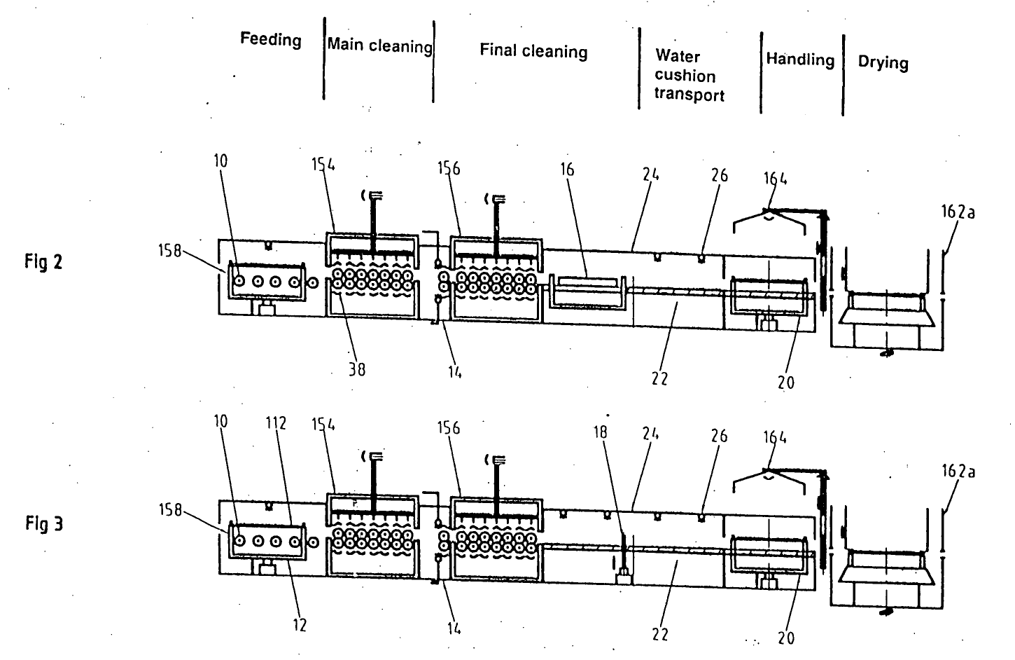

FIG. 2 schematically shows a first embodiment of an apparatus according to the invention.

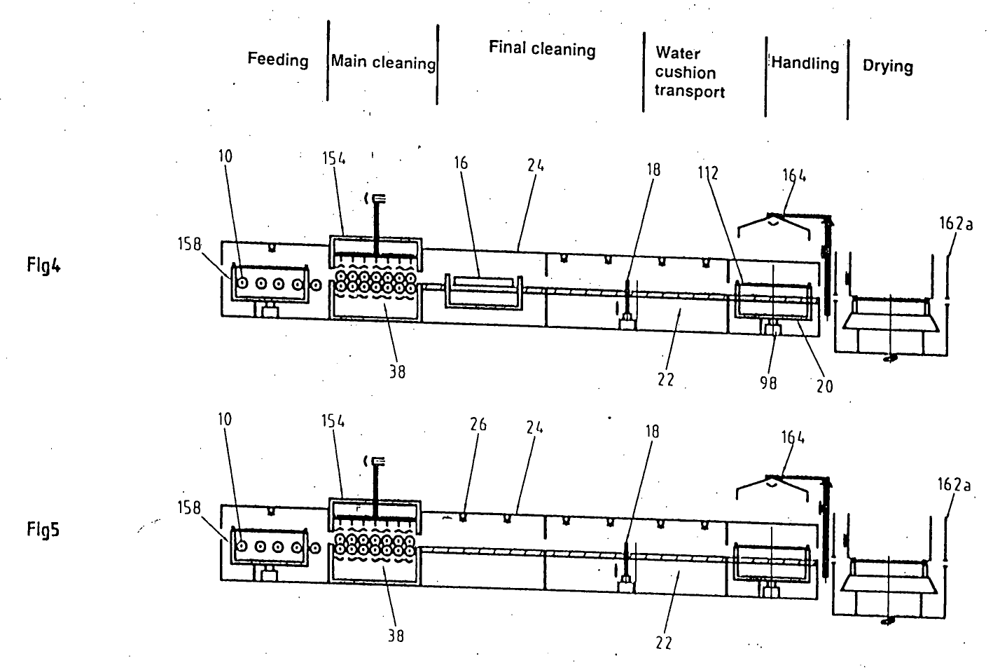

FIG. 3 schematically shows a second embodiment of an apparatus according to the invention.

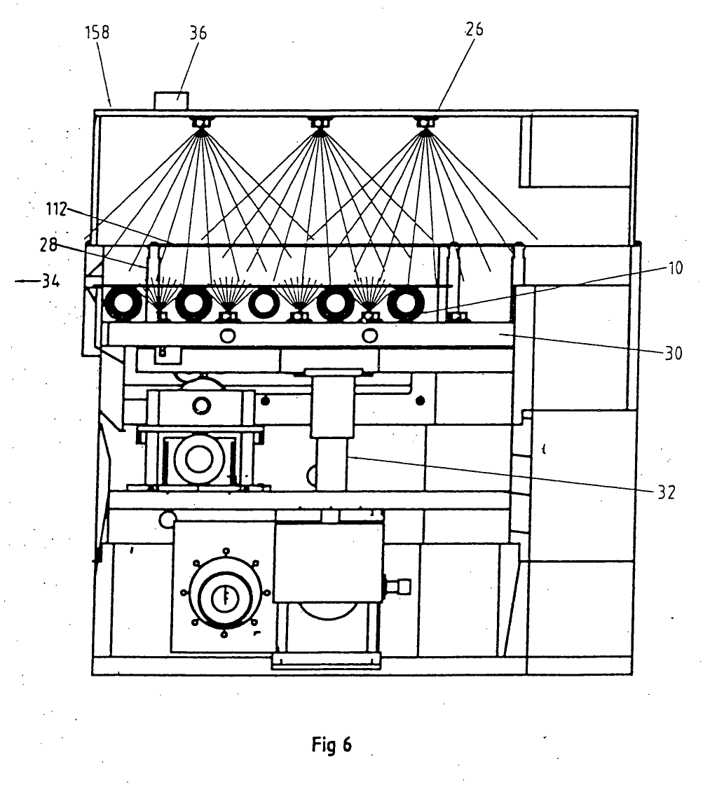

FIG. 4 schematically shows a third embodiment of an apparatus according to the invention.

FIG. 5 schematically shows a fourth embodiment of an apparatus according to the invention.

FIG. 6 schematically shows a side view of a feeding station of the apparatus according to the invention.

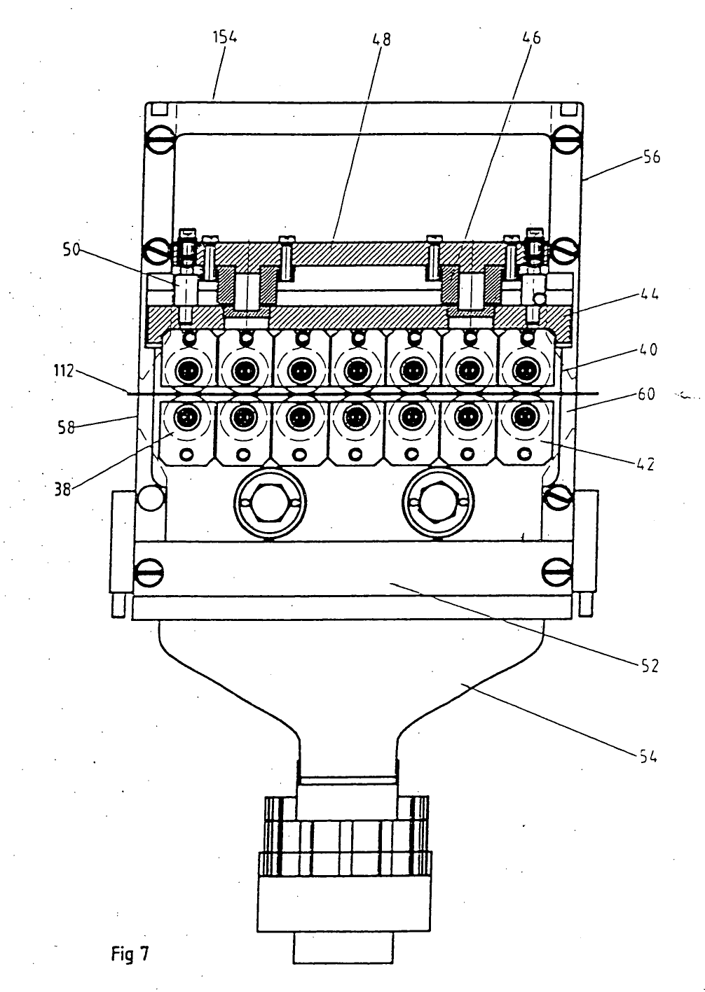

FIG. 7 schematically shows a main cleaning station of the apparatus according to the invention.

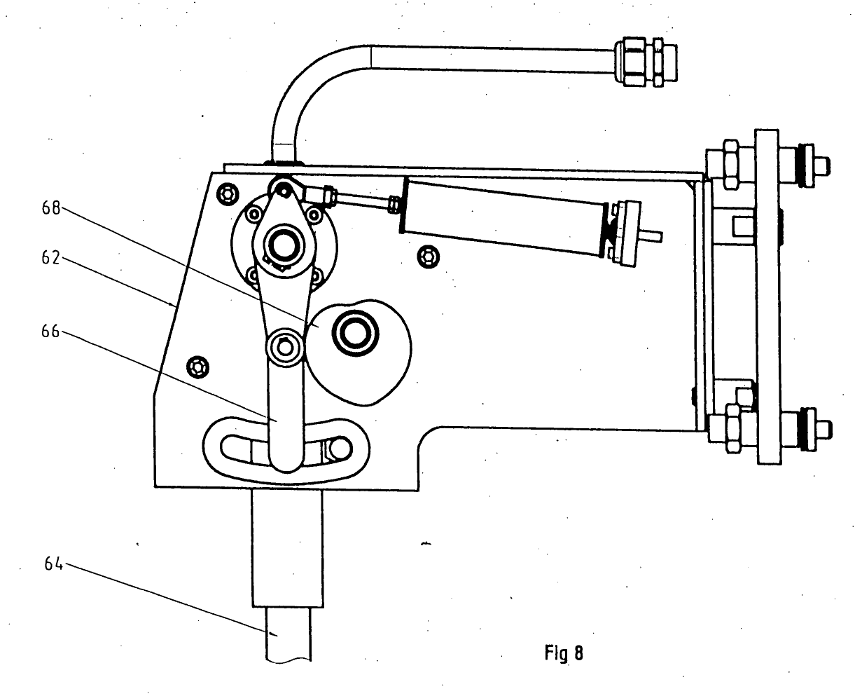

FIG. 8 shows a drop distributor for the main cleaning station of FIG. 7.

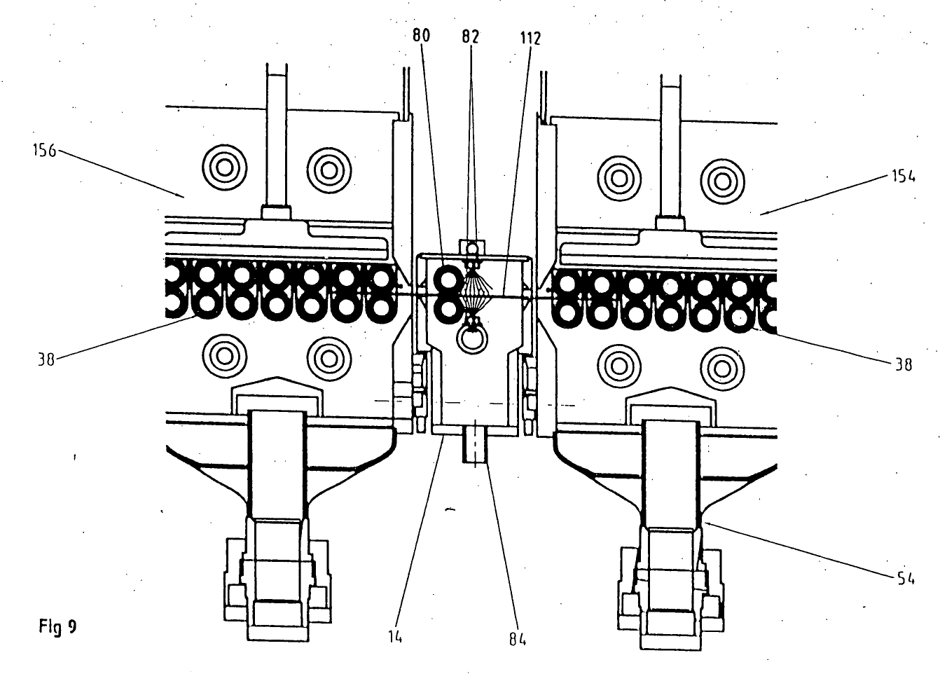

FIG. 9 shows an outline of a main cleaning station and a final cleaning station and a flushing lock between the stations.

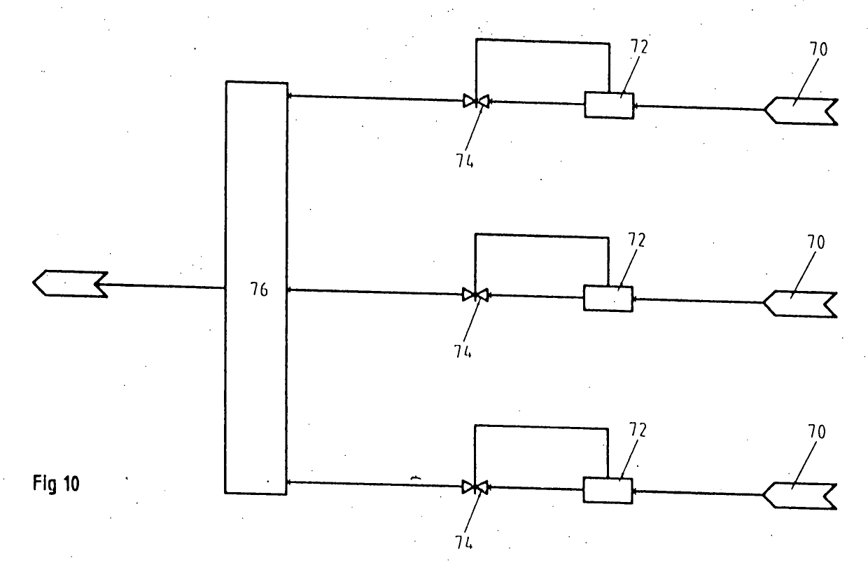

FIG. 10 schematically shows a flow chart for the supply of a cleaning and processing liquid to a cleaning station.

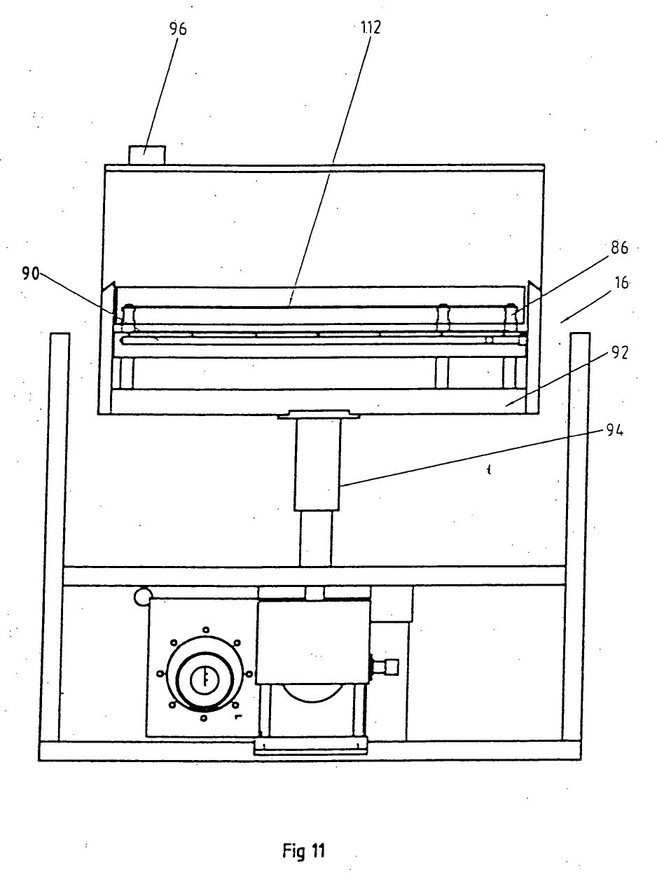

FIG. 11 schematically shows a withdrawal station of the apparatus according to the invention.

Referring to FIG. 1, a cleanroom 100 of a rectangular layout is shown in which individual units and devices are housed for the processing of wafers. They are schematically outlined in FIG. 1. The numeral 102 designates a charging and discharging station which has three platforms 104 for cassettes 106 which carry wafers. No specific reference will be made to the charging and discharging station. A first robot 108 serves for the removal of the wafers from the cassettes 106, during which the robot initially places each wafer on a cassette identification device 110 or retains it therein.

The robot 108 has been designed for handling dry wafers. The robot withdraws the wafers from the storage compartments of the cassettes and transfers them to the identification device 110 (one wafer 112 being shown in the identification device 110). Subsequently, the robot 108 conveys the wafer 112 to a transfer point 114 at which a film thickness meter 116 is also disposed.

A further robot 118 is disposed at an approximately central point in the cleanroom 100 to help convey the wafer from the transfer point 114 to an intermediate station 120. The intermediate station 120 has the deposition areas 122 to 128 which are arranged on a rotary support. Polishing plates 130 and 132 are rotatingly driven each on the sides opposite the support. Each polishing plate 130 includes two polishing heads 134, 136 and 138, 140, respectively. The polishing heads are linearly traversable between the positions shown in FIG. 1 in a position above a deposition areas 122 to 128. They are arranged to be vertically positionable and serve for transporting the wafers and holding them against the polishing plates 130, 132 to allow them to be polished there using the CMP process.

Two processing and cleaning stations 142, 144 are arranged between the polishing plate 130 and the intermediate station 120. Similar cleaning stations 146, 148 are arranged between the intermediate station 120 and the polishing plate 132. The processing and cleaning stations are pivotable between a position as is shown in the drawing of FIG. 1 and a position in which they are oriented towards a deposition area. Spatially, therefore, the stations 142 to 148 are located above the deposition areas 122 to 128, but can be traveled over by the polishing heads 134 to 140.

Each polishing plate 130, 132 has associated therewith a respective dressing fixture 150 and 152.

It can be seen that the entire polishing device including the intermediate station 120 and dressing device 150 and 152, respectively, is disposed in a separate compartment within the cleanroom 100.

A cleaning and drying device is arranged in another compartment of the cleanroom 100. The device includes a main cleaning station 154 and a final cleaning station 156 into which the wafers get from a feeding station 158. The robot 118 places the wafers in the feeding station, from which they are conveyed through cleaning facilities via a V-shaped transport runway 160 which preferably is a water runway. Reference to the individual stations will be made in detail below. The cleaned wafers travel to a stop point 162 which is arranged approximately in the rounded apex of the V-shaped runway before they are conveyed to a flushing and drying hydroextractor 162a by means of a robot arranged at 164. The robot 108 then helps transport the cleaned wafer from the flushing and drying hydroextractor 162a back to a cassette which is kept ready. It can be recognized that the robot 108 merely grips and transports dry wafers whereas the robot 118 only handles wet wafers.

The legs of the V-shaped runway are such as to extend the second leg approximately in parallel with the wall of the cleanroom 100 while the first leg including the main cleaning and final cleaning stations 154, 156 is obliquely directed inwards into the cleanroom. This helps obtain an arrangement which saves a lot of space. A further advantage of the V-shape is that the once-occurring change of direction saves the edges of the wafers very much.

FIGS. 2 to 5 schematically illustrate various embodiments of an apparatus for cleaning wafers. Those will be briefly discussed below.

The feeding station 158 is of an identical design in FIGS. 2 to 5. It has five transport rollers 10. A lifting device 12 picks up a wafer 112 after it is polished, and lowers it onto the rollers 10 for a transport to the main cleaning station 154. From the main cleaning station, the wafer gets to the final cleaning station 156 through a flushing lock 14 and, thence, to a Megasonic station 16 (in FIG. 2). In FIG. 3, the wafer travels to a stop station 18 from the final cleaning station 156 and, subsequently, to a withdrawal station 20 in order to be taken thence by the robot 164 to the drying station 162a. A water cushion transport line 22 is provided between the final cleaning station 156 or Megasonic station 16 and the withdrawal station 20. There is no final cleaning station 156 in FIGS. 4 and 5, and the Megasonic station 16 is provided instead in FIG. 4. FIG. 5 merely provides for the main cleaning station 154.

Except for the drying station 162a, the components described are arranged inside an elongate casing 24 on the ceiling of which spray nozzles 26 are mounted in some areas. In any case, the wafers are wet when located on all transport and retaining lines. Reference will be made below to the structure and function of the apparatus components which are schematically shown in FIGS. 2 to 5.

The feeding station 158 is illustrated in more detail in FIG. 6. The rollers 10, which are made of a soft, absorbent plastic material which is applied to a hard roller core, are jointly driven at a predetermined speed via a driving mechanism reference to which will not be made in detail. The driving mechanism is controlled by a control unit which is not shown. The way of mounting the rollers is not described either. Three retaining pins extend between the rollers 10 that are designed to grip a wafer 112 by its edge and hold the wafer. The retaining pins 28 are attached to a platform 30 which can be adjusted in height by means of a lifting device 32. Therefore, the wafer 112 can be lowered onto the rollers 10 by lowering the retaining pins 28. The rollers are driven so as to transport the wafer in the direction of the arrow 34.

A liquid, which preferably is DI water, is sprayed onto the assembly through the nozzles 26 to prevent residues from drying to the retaining pins 28. A detector 36 discovers whether there is a wafer in the feeding station 158. The detector 36 is coupled to the control unit which is not shown.

As is evident from FIGS. 2 to 5 and 7, the main cleaning station 154 has seven pairs of rollers where each pair has an upper roller and a lower roller. As can be appreciated from FIGS. 2 to 5 the first, third, fifth, and seventh pairs of rollers are driven in one sense of rotation so that a wafer led therebetween is transported in the direction of conveyance. The remaining pairs of rollers, which are designed 38 altogether, are driven in the opposite sense. Like the rollers 10, the rollers are made of liquid-absorbent, soft plastic material.

In FIG. 7, it can be seen that the lower and upper rollers are supported each by separate frames 40, 42. The frame 40 contains an upper panel 44 which is suspended on a stationary panel 48 by means of soft, elastic elements 46. Shifting cylinders 50 act between the panel 48 and panel 44 to force the frame 40 against the waver 112 which was received, at a predetermined contact pressure. The contact pressure does not depend here on the thickness of the wafer 112. Below the pairs of rollers, there is a collection tray 52 for the liquid which is dripped onto the rollers. Reference to this fact will be made later below. Furthermore, an exhaust air duct 54 is located at the lower end of the casing 56 in which the components described are accommodated. The casing is substantially closed and has a lateral inlet opening 58 and a lateral outlet opening 60 for the wafer. Electric driving motors and gearboxes, which are not shown, are designed to allow the rollers of the pairs of rollers 38 to rotate at different speeds in different senses with a plurality of the pairs of rollers bringing about the transport of the wafer as transport rollers whereas the remaining pairs of rollers rotate as cleaning rollers in a sense contrary to the sense of transport to achieve an optimum cleaning effect. The transport and cleaning rollers may be driven at the same speed or at different speeds.

Each cleaning roller has associated therewith a media distributor which is shown in a perspective view in FIG. 8. It is generally designated 62 and has a nozzle 64 which is connected to a media supply. The nozzle 64 is coupled to a pendulum 66 which is operated by a cordiform cam 68. The cordiform cam 68 is set into rotation by a drive which is not shown. This manner achieves that the movement of the nozzle 64 is uniform in its longitudinal direction above the rollers. The dwell time of the nozzle 64 above each roller portion is equally long. This helps attain a low consumption of chemicals and cleaning medium.

FIG. 10 schematically points out the way the supply of various chemicals and media can take place at the same time at a desired ratio of mixing.

FIG. 10 illustrates three sources for media each at 70, 72 and 74. They are connected, via a volumetric flowmeter 72 and a control valve 74, to a statical mixer 76 from which supply is then performed, e.g. to the nozzle 64, e.g. via a proportioning pump. The flow rate meter 72 also is a controller so that the desired, predetermined volume of media gets to the mixer 76 from the media sources 70 to 74.

The structure and action of the main cleaning station 154 and final cleaning station 156 are the same so that the latter will not be described in more detail here. FIG. 9 describes the region between the cleaning stations 154, 156 in more detail with the flushing lock 14 between the stations. The flushing lock 14 has a pair of rollers 80 which is driven by an appropriate driving mechanism such that the rollers move against the direction of transport of the wafer 12, which is from right to left in FIG. 9. As a result, they produce a cleaning effect as do the pairs of cleaning rollers 38 of the main cleaning station 154. The rollers of the pair of rollers 80 are also made of a soft, liquid-absorbent plastic material. Nozzles 82 above and below the wafer 112 initially serve for flushing the waver and removing the material which is still left on the wafer 112 after it is cleaned or processed. The rollers 80 will then clean it finally. This prevents the medium used in the main cleaning station 154 from being transferred to the cleaning station 156. The length of the flushing lock 14 is smaller than is the length of the wafer 112. As a result, the wafer 112 is transported through the flushing lock 14 solely by the transport rollers of the main cleaning and final cleaning stations. The flushing lock also includes a bottom tray (not shown in detail) and a drain connection 84.

As can be seen from FIGS. 2 and 4, a Megasonic station 16 may be employed in addition or as an alternative to a final cleaning station. In the Megasonic station 16, the wafers are cleaned of very small particles (e.g. <0.5 μm).

The cleaning liquid used in the Megasonic station 16 may be DI water or a cleaning solution. An arrangement of an individual chamber of a Megasonic station 16 is shown in FIG. 11. It has retaining pins 86 which halt the incoming wafer 112 (from the left in FIG. 1) and retain it afterwards at a minimum of three edge points. Transport takes place via the transport rollers of the final cleaning station 156 in FIG. 2 and by means of the transport rollers of the main cleaning station 154 in the embodiment of FIG. 4. The Megasonic station 16 has arranged therein a tube 90 with outlet openings the direction of which extends obliquely to the left so that a wafer 112, if released by the liftable and lowerable retaining pins 86, can continue be transported to the left by means of a directional liquid film. FIG. 11 also shows a tray 92 which can be raised by means of a lifting device 94 and receives a coupling liquid for an ultrasonic treatment of the wafer 112. After being inundated, the wafer 112 will be in a horizontal position in an area filled with liquid where the level of the liquid is approximately the same below and above the wafer 112. An upper and a lower Megasonic transducer (which are not shown in detail) are provided, which can be mounted on stationary basin walls.

As an alternative to the stationary cleaning of a wafer 112 in a Megasonic station 16, which also has a buffering effect with regard to the transport and has a detector 96 to detect the presence of a wafer 112, cleaning can be performed while the waver is being transported, the relevant device not being shown here. The Megasonic station which uses the passage principle features several upper and lower Megasonic transducers which are oriented perpendicular to the direction of wafer transport, with inflow openings for a cleaning liquid being located between the transducers. The cleaning liquid serves as a bridge of liquid between the transducers and the wafer. The flow of liquid in the station is directed from the inlet to the outlet since the flow is also meant to support the transport of the wafer. There can be a liquid drain between the Megasonic fields to allow the load of particles to be discharged along with the cleaning liquid.

Finally, a Megasonic nozzle system may be provided. The workpiece is held by the edge on a rotor in this station. While the wafer rotates it is radially run over by a Megasonic nozzle unit, which causes the entire surface of the workpiece to be reached. The cleaning liquid is fed through the Megasonic nozzle, which automatically results in an ultrasonic sound coupling between the transducer and workpiece.

Within and subsequent to the final cleaning of the wafers, their transport takes place via a water cushion in the channel casing 24. Their forward transport is solely performed by a directional water inflow. The nozzles used here are realized by directional inflow channels, for example. The water cushion and an extra flushing procedure cause the two sides of the wafer to be permanently rinsed during its transport. The flushing liquid used typically is DI water. Diluted chemicals can be used for specific applications. The main drain for the flushing liquid is preferably located at the end of the channel 24. However, drains (not shown) can also be interposed therebetween to ensure an improved discharge of particles and chemicals.

FIGS. 3, 4, and 5 provide for a stop station 18 which is within the water cushion transport line 22. The stop station 18 halts the wafer which was cleaned before. As a result, a buffering function is achieved. For example, the stop station may be realized by retaining pins and is moved into the path of wafer transport by means of a lifting device which is not depicted in detail. The region of the stop station 18 provides for a detector which is not shown and checks up whether there is a wafer at this point. The transport of a wafer 112 from the feeding station 158 will be released only when the stop station 18 is not occupied by a wafer. As was mentioned before those procedures are controlled via the control unit which is not shown. In the apparatus of FIG. 2, the Megasonic unit 16 accomplishes the buffering function so that a separate stop station is unnecessary.

The wafer, after exiting the stop station 18, is halted by retaining pins of a withdrawal station 20 where the retaining pins can be raised by means of a lifting device 98 to keep the wafer 112 ready for withdrawal. It is withdrawn by means of the robot 164 which can raise the wafer while transporting it to the drying station 162a. The withdrawal station 20 also has associated therewith a detector for wafers 112. The stop station 18 allows to continue the transport of a wafer only if a wafer has not been received in the withdrawal station 20.

The drying station 162a contains a tower-like casing into which a wafer is moved by the robot 164 through a lock which is not shown. Arranged in the drying station 162a is a flushing and drying hydroextractor by which the wafer is set into rotation at speeds up to 2,000 rpm. The hydroextractor is driven by an electric motor. The drying station runs two phases, i.e. the process steps of flushing hydroextraction and dry centrifuging. Operation is possible at different speeds here. The wafers are held on the rotor by means of retaining pins. Media supply lines allow to apply flushing liquids, gases or vapour to both the upper side of the workpiece and lower side of the workpiece. A typical flushing liquid is DI water. Typical gases are mixtures of an inert carrier gas such as nitrogen and a vapour of a water-soluble, surface tension reducing substance, preferably a short-chained alcohol such as isopropanol.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. An apparatus for cleaning wafers using the CMP process, comprising:
a transport device of a feeding station at the beginning of a cleaning line having a plurality of transport rollers disposed and driven transversely to the direction of transport;
a main cleaning station having several pairs of transport rollers for transporting wafers through the main cleaning station and several pairs of cleaning rollers for cleaning said wafers, wherein a supply of a cleaning medium to the pairs of cleaning rollers is provided in said main cleaning station;
a withdrawal station at the end of the cleaning line in which a robot takes up a wafer and transports it to a drying station, said withdrawal station having a first detector;
a water cushion transport line disposed between the main cleaning station and the withdrawal station;
a stop station between the main cleaning station and the withdrawal station which has associated thereto a second detector; and
a control device which presets a predetermined ratio of the speed of the transport rollers of the transport device and that of the pairs of transport rollers of the main cleaning station and does not release a transport device to the feeding station until there is no wafer at the stop station, and releases a wafer to the withdrawal station only when there is no wafer therein.

30. An apparatus for the CMP polishing and cleaning of wafers in which the wafers, after undergoing polishing on a polishing plate, are transported to a start position of a cleaning device by means of a first robot and the cleaning device has at least one main cleaning station and a drying station and has a stop station between the main cleaning station and the drying station wherein a conveyance line between the start position and the drying station is a V-shaped runway, and wherein the main cleaning station is associated with a first leg of said V-shaped runway and the drying station is associated with the second leg of the V-shaped runway.

31. The apparatus according to claim 30, wherein said apparatus is disposed in a cleanroom having a rectangular layout and the second leg of the V-shaped runway extends approximately in parallel with one side of the cleanroom.

32. The apparatus according to claim 30, wherein the stop station is disposed in the apex area of the V-shaped runway.

33. The apparatus according to claim 29, wherein the transport device, main cleaning station, drying station, stop station and withdrawal station are each disposed along a V-shaped transport runway for a wafer.

34. The apparatus according to claim 29, wherein retaining pins, which are adjustable in height, are disposed between transport rollers of the feeding station for the reception of a polished wafer by its edge.

35. The apparatus according to claim 29, wherein the feeding station has associated thereto a third detector for detecting the presence of a wafer.

36. The apparatus according to claim 29, wherein the transport rollers have associated therewith a spraying device for wetting a received wafer.

37. The apparatus according to claim 29, the main cleaning station is followed by a final cleaning station or processing station having pairs of transport rollers and pairs of cleaning rollers which have associated therewith a device for the supply of a cleaning and/or processing liquid.

38. The apparatus according to claim 29, wherein the pairs of rollers are housed in a closed casing having a lateral charging opening and discharging opening, with a collection tray in a lower portion and an exhaust air connection, wherein means are further provided in the casing for appropriately routing the air.

39. The apparatus according to claim 29, wherein the rollers are forced against the wafer at a predetermined pressure regardless of the thickness of the wafer.

40. The apparatus according to claim 37, wherein the pairs of cleaning and/or processing rollers are rotationally driven in direction which is opposite to that of the pairs of transport rollers.

41. The apparatus according to claim 29, wherein the pairs of cleaning rollers have associated therewith a drop distributor which is moved along a roller of a pair of rollers, wherein the movement of the drop distributor is chosen such that its dwell time above each roller portion is made equal.

42. The apparatus according to claim 40, wherein the drop distributor is preceded by a mixer and flow rate controllers, wherein proportioning pumps or the like are arranged in the lines leading to the mixer to adjust a desired mixing ratio of a cleaning and/or processing liquid.

43. The apparatus according to claim 37, wherein a flushing lock is disposed between the main cleaning station and the final cleaning or processing station, the length of said flushing lock being smaller than the length of a wafer and the flushing lock having arranged therein a pair of rollers, wherein the sense of rotation of said rollers is opposed to the direction of transport of the wafer and which has associated therewith a supply for a flushing liquid.

44. The apparatus according to claim 29, wherein each of the rollers have a soft, liquid-absorbent plastic jacket on a plastic hard core.

45. The apparatus according to claim 29, wherein the main cleaning station is followed by a Megasonic cleaning station.

46. The apparatus according to claim 45, wherein the wafer is stationarily held by an edge in the Megasonic station and can be immersed into a chamber wherein transducers of said Megasonic station are arranged on walls of the chamber.

47. The apparatus according to claim 46, wherein the Megasonic station has associated therewith a water cushion transport line.

48. The apparatus according to claim 45, wherein a plurality of upper and lower Megasonic transducers are arranged along a transport line.

49. The apparatus according to claim 47, wherein a supply for a cleaning liquid is provided between the transducers.

50. The apparatus according to claim 48, wherein a liquid drain is provided between the transducers.

51. The apparatus according to claim 47, further comprising a rotor that picks the wafers up by an edge thereof, and a Megasonic nozzle unit that radially traverses about the rotating wafer.

52. The apparatus according to claim 47, wherein said water cushion transport line is arranged in a closed channel in which directional nozzles cause a directional transport of the liquid.

53. The apparatus according to claim 51, wherein the water cushion transport line has associated therewith spray nozzles to spray the transported wafer transported with a cleaning and/or chemical-containing liquid.

54. The apparatus according to claim 34, wherein the height adjustable retaining pins define the stop station in the water cushion transport line.

55. The apparatus according to claim 29, wherein the withdrawal station has a lifter unit that grips the wafer fed on the transport line by an edge thereof and raises said wafer into the drying station by means of a robot.

56. The apparatus according to claim 29, wherein the drying station has a flushing and drying hydroextractor with retaining pins on a rotor for causing the wafer to rotate with the rotor and a supply for a flushing liquid and/or gases or vapors.
